(19) United States
(12) Patent Application Publication
(10) Pub. No.: US 2026/0054463 A1
(43) Pub. Date: Feb. 26, 2026

(54) PACKAGING SYSTEM

(71) Applicant: Indyra Inversion, S.L.U, Vigo, Pontevedra (ES)

(72) Inventor: Jorge TORRE SARMIENTO, Vigo, Pontevedra (ES)

(21) Appl. No.: 19/102,775

(22) PCT Filed: Feb. 28, 2024
(86) PCT No.: PCT/ES2024/070119

§ 371 Date: Feb. 10, 2025

(30) Foreign Application Priority Data
Jun. 23, 2023 (ES) P202330523

(51) Int. Cl. B31B 50/26; B31B 50/73; B31B 100/00; B31B 110/35; B31B 120/10; B65D 5/20; B65D 5/24

(52) U.S. Cl. CPC B31B 50/262; B31B 50/734; B65D 5/2057; B65D 5/24; B31B 2100/0024; B31B 2110/35; B31B 2120/102; B31B 2247/00; B65D 2401/10

(57) ABSTRACT

The present invention relates to a packaging system, which creates a packaging consisting of a rectangular or square tray, watertight perimeter flaps and two covers. It comprises a folding station consisting of
a frame with a central gap corresponding to the dimensions of the tray;
a skid at each corner of the frame, protruding from the top.

In turn, the plate comprises
a flap on each edge of the tray, joined together by corners comprising diagonal, radial notches,
two covers on two flaps facing each other, each with a pair of insertion tabs for inserting between the flaps.

### TECHNICAL SECTOR

The present invention relates to a packaging system that allows a quick, simple and efficient packaging to be created from a simple sheet with reduced scrap material, which, in its fullest embodiment, does not require any additional elements.

### STATE OF THE ART

Various types of packaging, of many kinds, are known in the state of the art. Among them, solutions have always been developed, especially for logistics shipments, based on the well-known American box. This American box is a regular structure closed with adhesive on one side edge, equipped with two pairs of flaps at both ends, upper and lower, which, once closed, is sealed with packaging tape of various types. Self-assembly boxes are also known, such as ES1077780U, in various formats, as well as the padded envelopes. However, there is no known packaging that combines in a single element, the efficiency or virtues of all of them, that does not require any adhesive additives, laces, packaging tape or glue for mounting, or complex self-closing and locking manoeuvres of its different portions, and the surface development of which also allows the cutting plate to be fully utilised, but also that, once closed, is sealed and inviolable, with a simple label, or even without it.

All of the above devices, have a number of common features, such as the need for using one or in some cases two or more forms of gluing, or in the absence thereof, the need for using packaging tape for closing them. In the case of self-assembly boxes, even the most modern ones, their surface development is very costly, with a high percentage of scrap material. Furthermore, assembly usually takes several minutes and several manoeuvres, especially on the side flaps. Although some models have automated means, said means are quite complex and having several manoeuvres, no matter how fast they are, they are not really efficient.

The solution to these problems is provided by the system of the invention, in its fullest embodiment.

### BRIEF EXPLANATION OF THE INVENTION

The invention is a packaging system according to the claims. With its various embodiments, it solves the problems of the state of the art.

The present invention is based on the design of a regular shaped plate fitted to a surface with an optimal use of the surface, in order to reduce any production waste as much as possible, which is a common feature in most current embodiments.

The packaging system is intended for packaging consisting of a folding plate comprising a tray, rectangular or square, perimeter flaps and one or more covers. The system comprises a folding station and a series of plates (consumables) for creating the package. The sheets are generally made of corrugated cardboard, but they can be made of other similar material.

The folding station consists of a frame with a central gap corresponding to the dimensions of the tray. At each corner of the frame there is a skid protruding from the top. Top supports can be added as an option, which also protrude, at points on the frame other than the corners. These upper supports are of equal or lesser height than the skids, preferably the same.

In turn, the plate comprises a flap on each edge of the tray. The flaps are joined together by corners comprising diagonal, radial notches. Thus, the flaps and corners form a continuous ring, without cuts. Two flaps facing each other have two covers, each with a pair of insertion tabs for inserting between the flaps. To do so, the tabs emerge from the sides of the covers.

This produces a completely novel and efficient packaging.

To facilitate the operation of the folding station, it is preferable that it has a stop, side and front, for positioning the plate.

For easy insertion of the tabs in their closing position, it is preferable that the tabs have a curved S-shaped edge, on the side closest to the tray. This curved edge aids the insertion by creating a “tip”.

Once the second cover is in place, it can be attached using various methods. A preferred method, as no external elements are required, is that the second cover has two locking skids on its tabs in alignment with the corresponding corner perforations. Ideally, at least one skid has a vandal-proof security perforation that warns of unauthorised opening.

Other variants are set forth in the dependent claims and are described below.

### DESCRIPTION OF THE DRAWINGS

For a better understanding of the invention, a set of drawings is included, comprising:

FIG. 1 shows an exemplary plate.

FIG. 2 is a perspective view of an exemplary folding station.

FIG. 3 is a view of the above example with a plate placed thereon.

FIG. 4 is a view of the above example, where the first cover is being inserted between the flaps.

FIG. 5 is a view of the above example just before fitting the second cover.

FIG. 6 is a detail view of a plate with a skid for retaining the tabs of the second cover.

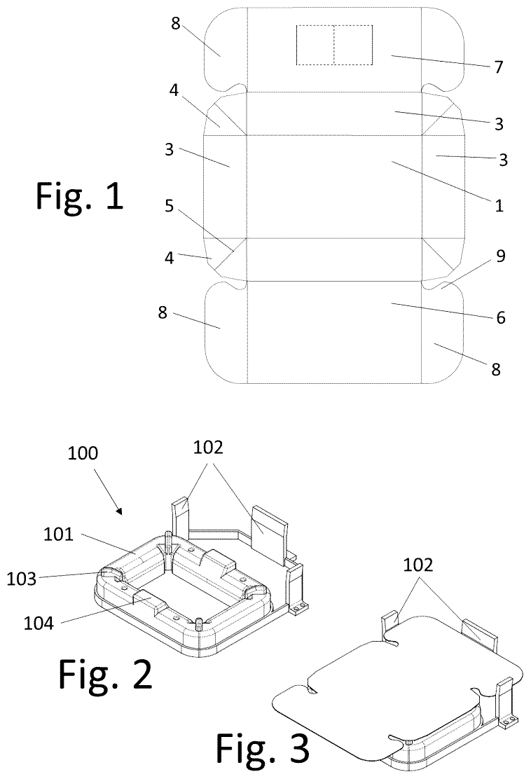

### EMBODIMENTS OF THE INVENTION

Several embodiments of the invention are briefly described below as an illustrative and non-limiting example thereof.

The packaging system of the embodiment shown is based on a series of sheets of cardboard or similar material, and a folding station (101) for folding the sheets to form the packaging.

Each plate has a base or tray (1), with a rectangular or a square shape, surrounded by a flexible perimeter ring. The ring consists of four flaps (3), on each edge of the tray (1) and four corners (4) with a diagonal radial notch (5). In other words, the notch (5) is oriented approximately towards the centre of the tray. This notch (5) allows the corners (4) to be folded when the flaps (3) are folded. This leaves the packaging without gaps and slots when the flaps (3) are folded. In two flaps (3) facing each other, generally those on the larger sides of the tray (1), two covers (6,7) are provided with two pairs of tabs (8) for insertion into the flap (3). The tabs (8) have an S-shaped curved edge (9) on the side closest to the tray (1).

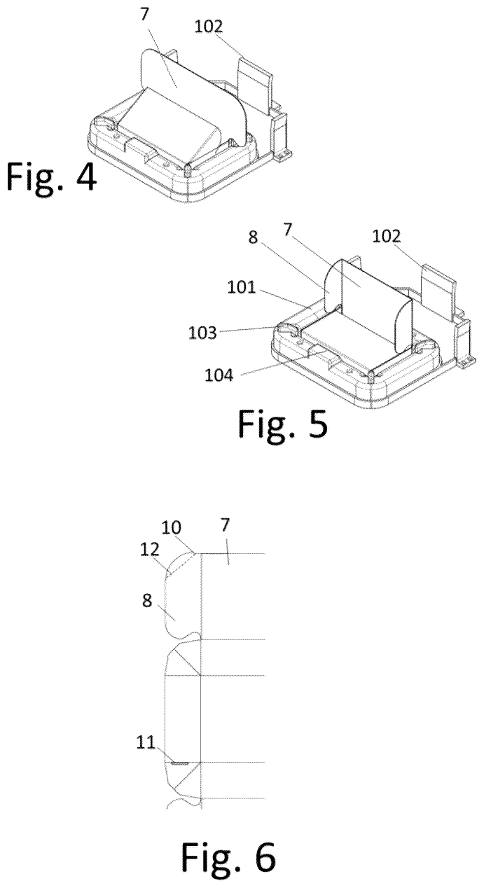

The folding station (100) for use with the above plate is shown in FIGS. 2-5. It is based on a frame (101) with a central gap corresponding to the dimensions of the tray (1). A stop (102) allows the user to easily move the plate (FIG. 3) into position, so that the tray (1) is fully above the frame (101). The corners of the frame (101) have skids (103) on an inclined plane, protruding from the frame (101) to ensure that the corners (4) are folded in the desired direction. Thus, when the user pushes the tray (1) downwards, the runners (103) are the first to contact the plate and start by bending the corners (4) by the notches (5), towards the inside of the tray (1).

It can be seen how the frame (101) can have upper supports (104), protruding from the rest of the frame (101), where the flaps (3) are supported prior to pushing. These upper supports (104) can be aligned with the runners (103) and are especially designed for long flaps (3), so that the bending stress due to thrust does not remain only at the corners (4).

The tray (1) may have markings (14) to indicate the place where the user has to push to fold the flaps (3) without deforming the tray (1).

For the assembly of the packaging, the flaps (3) are lifted, so that the corners (4) are dragged by the flaps and are folded by their diagonal notch (5). The corners (4) are pushed towards the inside of the packaging by the skids (103) and provide rigidity to the assembly. Once the flaps (3) have been lifted, the packaging can be refilled. When the packaging is to be closed, the first cover (6) is applied to the tray (1) and its tabs (8) are inserted adjacent to the flaps (3). The second cover (7) is then folded down, its tabs (8) being between the flaps (8) of the first cover (6) and the flap (3). This clamp between the tabs (8) and the flaps (3) retains the second cover (7) and closes the packaging perfectly. The first cover (6) holds the contents.

At this point a small adhesive, e.g. a label, can be applied to ensure that the second cover (7) does not open. This label can be that which includes the shipping details. In the embodiment depicted, the covers (6,7) may be equipped on their respective tabs (8), with two locking protrusions or skids (10) in alignment with respective perforations (11) in the corresponding corners (4). This realisation makes it possible, in a simple manner, than in case of re-use, for example, in the event of a return, the packaging can be reused without the use of fasteners or seals.

The skid (10) may be fitted with a vandal-proof security perforation (12), more fragile. This detaches the end of the skid (10) in the event of an opening attempt. Thus, it serves as a seal, ensuring that the receiver can know whether the package has been opened. As this security perforation (12) is inside the packaging, it is not possible to manipulate it to open the package. In contrast, the user detects that the skid (10) offers no resistance to opening, in other words, that the security perforation (12) is broken.

Thus anchored, the device is able to withstand all transport incidents without any problems.

In the latter case, recycling is equally easy, since being fully made of unsorted recyclable materials, it can be placed in any container intended for paper, making it a fully sustainable type of packaging. The folding lines (notches (5) and gaps between flaps (3), tray (1), covers (6,7) and tabs (8)) can be made by pressing a line.

1. A packaging system, for packaging consisting of
a folding plate comprising a rectangular or square tray; perimeter flaps, wherein the plate comprises a flap on each edge of the tray, joined together by corners comprising diagonal, radial notches; and one or more covers and
a folding station comprising a frame with a central gap corresponding to the dimensions of the tray;
the system being characterised in that
the folding station comprises a skid at each corner of the frame protruding from the top, and wherein the frame has upper supports protruding from the top, upper supports that are at the same height as the skids;
and wherein the plate comprises two covers on two flaps facing each other, each with a pair of insertion tabs for inserting between the flaps; wherein the tabs have a curved edge on the side closest to the tray.

2. The packaging system, according to claim 1, characterised in that the folding station has a stop for positioning the plate.

3. The packaging system, according to claim 1, characterised in that at least the second cover has two locking skids on its tabs in alignment with respective perforations in the corresponding corners.

4. The packaging system, according to claim 3, characterised in that at least one skid has a vandal-proof security perforation.
